(19) United States
(12) Patent Application Publication
(10) Pub. No.: US 2008/0114990 A1
(43) Pub. Date: May 15, 2008

(54) USABLE AND SECURE PORTABLE STORAGE

(75) Inventors: David M. Hilbert, Palo Alto, CA (US); Daniel-Alexander Billsus, San Francisco, CA (US); John E. Adcock, Menlo Park, CA (US); Wolfgang Polak, Sunnyvale, CA (US); Laurent Denoue, Palo Alto, CA (US); Eleanor G. Rieffel, Mountain View, CA (US)

Correspondence Address: SUGHRUE MION, PLLC, 2100 Pennsylvania Avenue, N.W., Washington, DC, 20037, US

(73) Assignee: FUJI XEROX CO., LTD., Tokyo (JP)

(21) Appl. No.: 11/558,886

(22) Filed: Nov. 10, 2006

(51) Int. Cl. G06F 12/14

(52) U.S. Cl. 713/189; 711/164; 711/E12.094; 711/E12.092

(57) ABSTRACT

Described is a technique for providing shared access to an encrypted portable memory device which improves both usability and security by allowing the owner of the encrypted storage device to designate access to specified files only to the next host to mount the secure disk. The number of steps required to perform a file sharing operation is greatly reduced with this system and access to the contents of the protected storage device can be granted with greater granularity.

### DESCRIPTION OF THE INVENTION

1. Field of the Invention

This invention generally relates to storage technology and, more specifically, to secure removable storage.

2. Description of the Related Art

The plummeting cost and skyrocketing capacity of USB flash drives, along with their plug-and-play nature has made them a popular choice for ad hoc file sharing between two or more computer platforms. Because of the ease of use and small size of the USB drives, corporations have legitimate concerns about the ease with which sensitive data may be moved about through these drives and possibly lost or stolen. Because of the aforesaid concerns, many corporations mandate the use of password protection on all portable storage, including flash drives. Unfortunately the common ways of implementing the password protection lead to a great decrease in usability for quick file transfers from one computer system to another even though this is a common reason for using a USB flash drive. The steps in a typical file transfer operation using secure drives are illustrated in FIG. 1.

As it would be appreciated by persons of skill in the art, the conventional file transfer operation illustrated in FIG. 1 is characterized by numerous inconveniences and inefficiencies. Specifically, the drive owner must perform password authentication twice—once on the source computer system and once on the target computer system. In addition, the drive owner must physically move to gain access to the target computer system in order to type the password. Moreover, the drive owner must manage the contents of the drive to remove items that should not be shared or that will confuse the receiving party. The second party must allow execution of a proprietary drive-login program, which is considered unsafe. Specifically, some IT departments have conservative policies which do not allow the execution of applications from removable media for fear of viral infections.

Insecure aspects of the common practice include the following. The drive owner must enter the drive password on an un-trusted computer system where key-logging may be performed (this is not an issue for drives with integrated biometric authorization). If the drive owner does not carefully remove files that are not relevant to the current operation, other sensitive information on the drive might be compromised, contaminated, or deleted. The second party must relinquish control of their computer system for the drive owner to enter the password. Furthermore, the drive-login program must be run on the second party computer system, opening the door to possible viral infection for the second party.

Therefore, the existing technology fails to provide a secure and efficient methodology for sharing files using encrypted flash drives between two or more computer systems.

### SUMMARY OF THE INVENTION

The inventive methodology is directed to methods and systems that substantially obviate one or more of the above and other problems associated with conventional techniques file sharing using encrypted removable storage.

In accordance with one aspect of the inventive methodology, there is provided a data storage device. The inventive data storage device includes an interface operable to connect the data storage device to a host system, a storage area and a drive control program. Upon the connection of the data storage device to a source host system using the interface, the drive control program is operable to determine if the data storage device is unlocked; validate a password and unlock the data storage device if the data storage device is determined to be locked; receive selected file information from a user; receive option information from the user; copy the selected files to the storage area; and save ticket information to the data storage device.

In accordance with another embodiment of the inventive methodology, there is provided a data storage device. The inventive data storage device includes an interface operable to connect the data storage device to a host system; a storage area; and a drive control program. Upon connection of the data storage device to a target computer using the interface, the drive control program is operable to obtain a public and private keys for the target computer, store the public key to the data storage device, and store the private key on the target computer. Upon subsequent connection of the data storage device to a source computer using the interface, the drive control program is further operable to receive selected file information from a user, encrypt the selected files using the stored public key, and copy the encrypted selected files to the storage area.

In accordance with yet another embodiment of the inventive methodology, there is provided a data storage device. The inventive device includes an interface operable to connect the data storage device to a host system, a storage area, and a drive control program. Upon connection of the data storage device to a source host using the interface, the drive control program is operable to obtain a public and private keys, store the private key on the source host, store the private key on a remote network server, receive selected file information from a user, encrypt the selected files using a session key and store the encrypted selected files to the storage area; and encrypt the session key and ticket information with the private key and store the session key and the ticket information to the data storage device. Upon subsequent connection of the data storage device to a target host using the interface, the drive control program is further operable to request the remote network server to validate the ticket information. If the ticket information is found to be valid, the drive control program receives from the remote network server the session key and decrypts the encrypted selected files using the received session key.

In accordance with yet further embodiment of the inventive methodology, there is provided a data storage device. The inventive data storage device includes an interface operable to connect the data storage device to a host system, a secure key storage area operable to store an encryption key, an encryption engine operable to encrypt information with the encryption key, a storage area operable to store the encrypted information; a ticket storage area operable to store ticket information; a protection logic comprising a clock, the protection logic operable to discard the information stored in the storage area or the encryption key if the ticket information is determined to be invalid, and a drive access program. Upon connection of the data storage device to a source host system using the interface, the drive access program is operable to receive selected file information from a user, obtain encryption key and store the obtained encryption key to the secure key storage area, copy the selected files to the storage area, and save the ticket information to the ticket storage area.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates numerous steps required to perform a simple file sharing operation between two computers using a conventional methodology;

FIG. 2 illustrates an exemplary embodiment of a dialog the user would navigate in the inventive system;

FIG. 3 illustrates series of actions and inputs that follow when files to share are dropped onto the drive access application;

FIG. 4 illustrates a process flow performed when drive authorization application is run, including checking for a pre-authorized session ticket;

FIG. 5 illustrates standard login/authorization operation when no pre-authorized access ticket is available;

FIG. 6 illustrates an architecture of the hardware based embodiment of the present invention;

FIG. 7 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

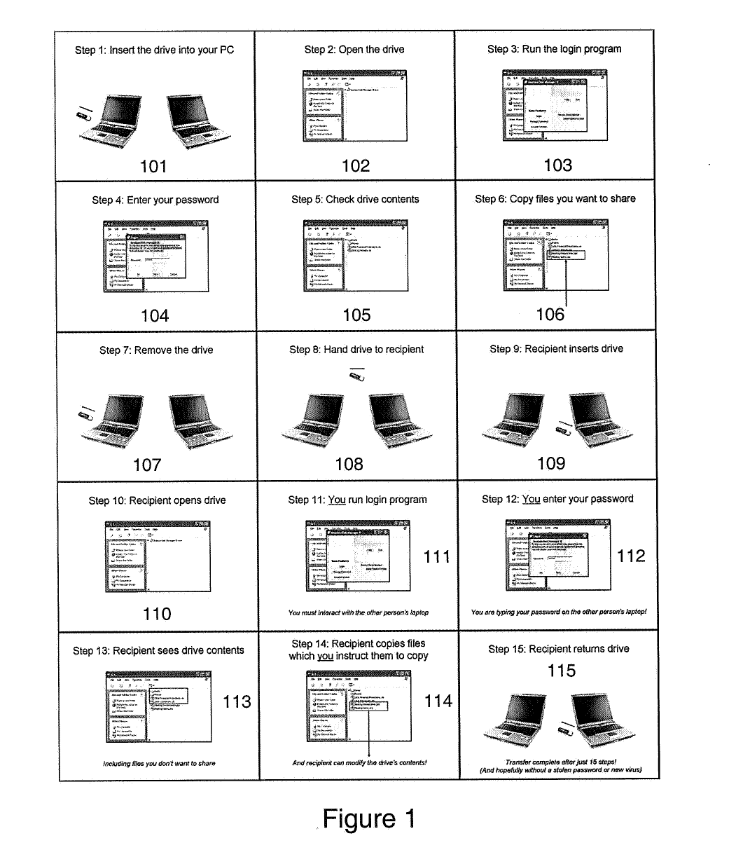

As illustrated in FIG. 1, current usage of password-protected portable storage devices (such as USB flash drives) for sharing files can be inconvenient as well as insecure. Specifically, to perform file sharing between a source computer and a target computer, the user needs to perform the following steps. First, the user providing the files needs to insert the removable drive into the source computer, open the drive, run the login program, enter the user's password, check drive content and copy the files to be shared to the drive. After that, the user needs to physically remove the drive from the source computer and hand the drive to the recipient of the shared files. The recipient then inserts the drive into the target machine and opens the drive. After that, the user providing the files runs the drive login program, and enters the drive's password for authentication. After authentication is complete, the recipient uses the drive's content and copies to the target computer the files, which the user providing the files instructs him or her to copy. Finally, the recipient returns the drive to the user.

The inventive techniques provides shared access to an encrypted portable memory device, which improves both usability and security by allowing the owner of the encrypted storage device to designate access to specified files only to the next host to mount the secure removable drive. The number of steps required to perform a file sharing operation using the inventive technique is greatly reduced and access to the contents of the protected storage device can be granted with greater granularity.

Specifically, an embodiment of the inventive concept ameliorates issues associated with the above-described conventional file sharing methodology using a model where the owner can create a transient copy of desired files on the USB drive. The unencrypted data remains valid only for a limited time, after which the drive returns to fully protected operation by erasing the unencrypted content.

In an embodiment of the inventive concept, the drive owner needs only to enter the drive password once to achieve a simple file sharing operation, and the owner's password is entered on the trusted computer only. The drive owner doesn't need to manage drive contents because only designated files are made visible to the second party. Both of these aspects of the inventive technique result in greater convenience and improved security of file sharing.

An alternative embodiment of the inventive concept allows the drive owner to designate that the next computer system to mount the drive be added to a list of hosts (whitelist), which are allowed to access the drive. Hosts on this list can access the drive without providing a password. When the drive is inserted and the access program is executed, the drive automatically verifies the identity of the host currently accessing the drive against the stored whitelist. It should be noted that in accordance with one embodiment of the inventive concept, the host is added to the access list by virtue of being the ‘next’ host to mount the drive. Thus, the drive owner does not need to commandeer or type the drive password on the other computer system in order to access the content of the drive.

It should be noted that the aforesaid concept is not limited to the USB flash memory drives only. Similar functionality may be implemented in conjunction with other portable storage devices, such as portable hard drives. However, because the USB flash memory-based drive is the most compact and convenient example of this technology it will be used as the primary exemplary embodiment of the inventive concept.

In one embodiment of the inventive technique, the system can be implemented without installing any specialized software on any computer system. All the information necessary for implementing the inventive technique can be stored within the USB drive itself. The same drive also stores the executable required for the advanced functionality.

### Interaction

Upon the insertion of the USB drive into the USB socket of the host computer system, only the access application stored on the USB drive is visible to the host computer. When the access application is executed, the user has the option of either unlocking the drive for complete access or choosing to provide unencrypted access to specified files by the next computer system to mount the drive.

The following are the steps in an exemplary procedure wherein the drive owner (user) wishes to share a file from his computer system with a second party. First, the drive owner inserts the USB drive into a USB socket of his or her own computer system. The drive owner then runs the drive access application and enters the drive password. After the authentication is complete, the user chooses to perform “quick copy” and selects files in the ensuing file chooser dialog. After that, the drive owner selects options on an options dialog including the amount of time the files should be available, whether they should be read-only or read-write, whether the disk should be writable. Typically a sensible default will be available and be the appropriate choice for simple sharing operations. This information is stored on the drive in what will be referred to in what follows as the access ticket.

The drive owner ejects the drive and passes it to the second party, who inserts the drive into the second (target) computer system. The second party runs the drive access application, which recognizes the ticket that has been just created and provides access to the files designated by the owner. Finally, the second party copies the appropriate files, which should be the only files visible, and returns the drive to the first user.

In an alternative embodiment of the invention, the interaction is initiated by dragging and dropping a selection of files from the computer storage onto the drive access application. Like in the first embodiment, the drive owner first inserts the drive into a USB socket of the user's computer system. After the insertion, the drive owner selects and drags files from his computer onto the drive-access application icon. The drive-access application validates the drive password and then presents a dialog with the option of performing a “quick copy” or a regular copy (into the secured area of the drive). After that, the drive owner selects access options as above, ejects the drive and provides the drive to the second party, who inserts the drive into the second (target) computer system. The second party runs the drive access application, which recognizes the ticket that has been just created and provides access to the files designated by the owner. Finally, the second party copies the appropriate files, which should be the only files visible, and returns the drive to the first user.

In the simplest embodiment of the invention, the USB drive may contain only transient contents for ad hoc sharing and have no persistent encrypted store, in which case there would be no password for the device. Any encrypted data residing on another device or disk would require a password step to access it.

Another access option allowed is for the next machine accessing the drive to be added to a whitelist. Machines in the whitelist can access the secure portion of the drive without entering a password. Hosts would be uniquely identified by information including their MAC address. Because machine-specific information is needed the drive-access application needs to be run on the second party computer system for the whitelist processing to take place. It should be noted that the process for inclusion of the target computer system into the whitelist in accordance with one embodiment of the inventive system does not involve entering password on the whitelisted computer system.

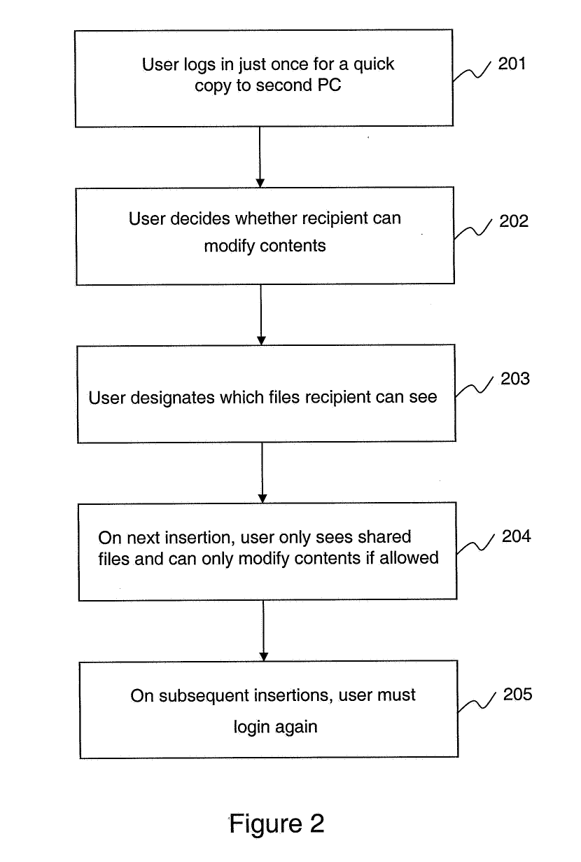

FIG. 2 illustrates exemplary dialogs the user would navigate in an embodiment of the inventive system. Specifically, at step 201, the user logs into the first host system. The aforesaid login process needs to be performed just once for a quick copy of the files to the second computer system. At step 202, the user decides whether the recipient of the drive should be allowed to modify the drive's content. At step 203, the files stored on the drive, that the recipient of the drive is allowed to see. On the next insertion, the user only sees shared files and can only modify the content if allowed to do so by the owner of the drive (step 204). On subsequent requests, the user must again perform the login procedure, see item 205.

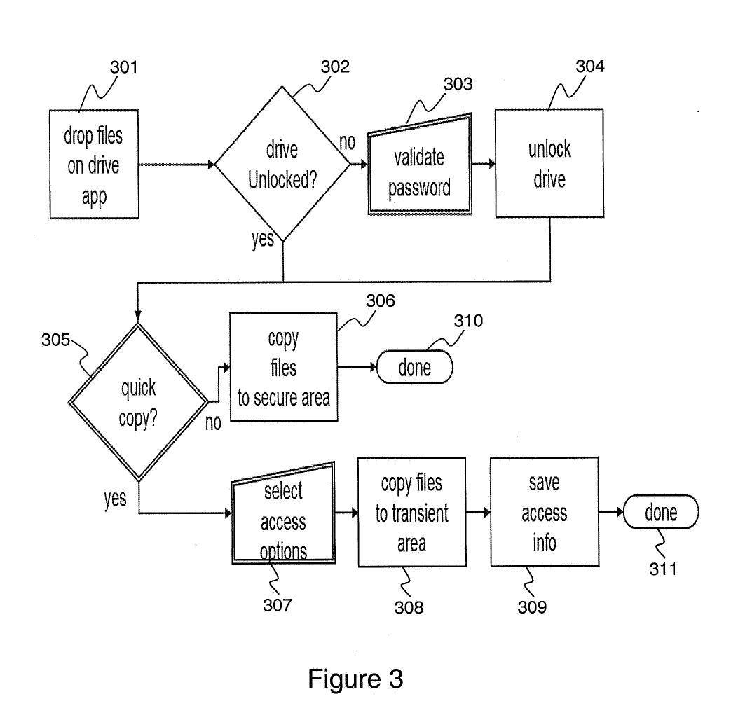

FIG. 3 illustrates a series of actions and inputs that follow when files to share are dropped onto the drive access application. Actions requiring user input are shown with double outlines. Specifically, at step 301, the user drops files on drive application. At step 302, the system determines whether or not the drive is unlocked. If the drive is locked, then the authentication procedure is performed. Specifically, at step 303 the password is validated and the drive is unlocked (step 304).

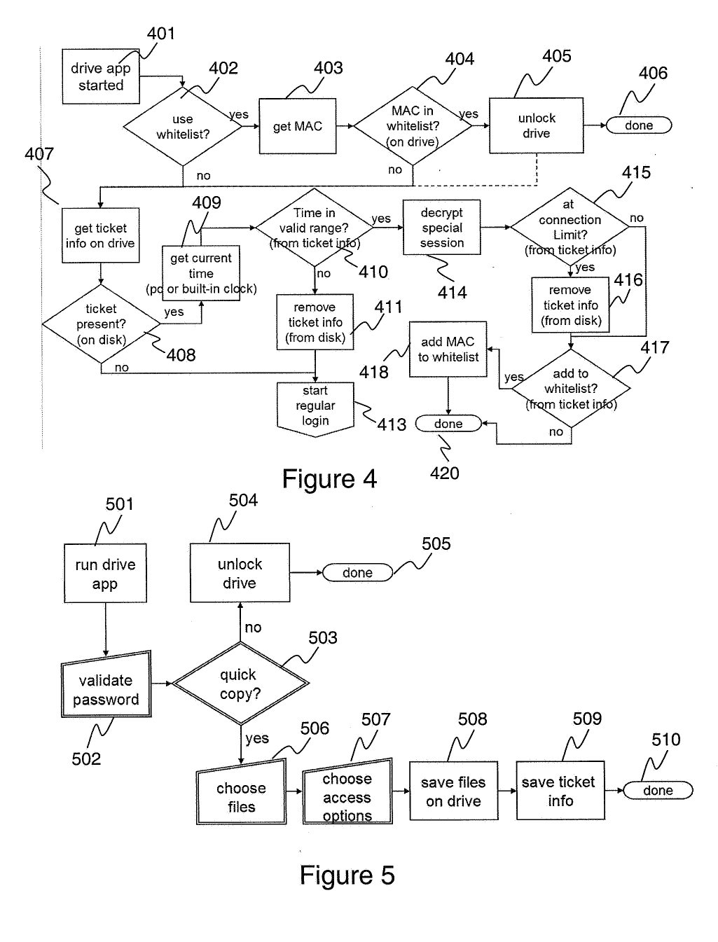

FIG. 4 illustrates a flow of a process, which is performed when drive authorization application is executed, including checking for a pre-authorized session ticket. It should be noted that there is no required user interaction in this sequence. At the end of the process the shared files will be visible to the user or if there are no shared files, the user will be prompted to perform password-enabled operations (if an encrypted component is included).

Specifically, at step 401, the drive application is started. At step 402, the system determines whether the whitelist feature is enabled. If so, the system obtains the MAC address of the computer system mounting the drive and compares the obtained MAC address with the MAC addresses on the whitelist (step 404). If a match is found, the drive is unlocked at step 405 and the process terminates at step 406. If the whitelist is not used or the MAC address of the computer system does not match the contents of the whitelist, the ticket information is read from the drive (step 407). If the ticket is present, the process proceeds to step 409, otherwise, the process continues to step 413. At step 409, the system obtains the current time either from a computer clock of a built-in clock in the storage drive. At step 410, the system compares the obtained current time with the time specified in the ticket. If the current time is within the valid time range, the system decrypts the special session at step 414. Otherwise, the regular login session is initiated at step 413. After the special session is decrypted, the system verifies if the specified connection limit has been exceeded (step 415). If so, the ticket information is removed from the drive (step 416). At step 417, the system determines whether the host should be added to the whitelist. If so, the MAC address of the host currently mounting the drive is added to the whitelist at step 418 and the process terminates at step 419.

FIG. 5 illustrates standard login/authorization operation when no pre-authorized access ticket is available. The drive is either unlocked for normal access or used to store transient content. Both operations required a password which would ideally be shared between the two modules (the protected access ticket storage and the encrypted data area). Specifically, at step 501, the drive application is executed The password is validated at step 502. If it is determined at step 503 that a quick copy operation has been requested by the user, the user chooses the files to be copied at step 506. After that, at step 507, the user chooses the access options. The files are saved on the drive at step 508, while the ticket information is written at step 509, whereupon the process terminates at step 510. On the other hand, if it is determined at step 503 that a quick copy has not been requested, the drive is simply unlocked at step 504, whereupon the process terminates at step 505.

### Access Information (Ticket)

The access ticket, which incorporates information describing the parameters of the file sharing operation, is stored on the USB removable drive. The ticket controls the access to the content of the removable drive. Specifically, the ticket may contain the information described below. Specifically, the ticket may include information on the number of accesses or insertions of the drive for which the ticket is valid; the time interval for which the ticket is valid as well as the rights granted by the ticket (read only or read-write).

### Hardware-Based Implementation

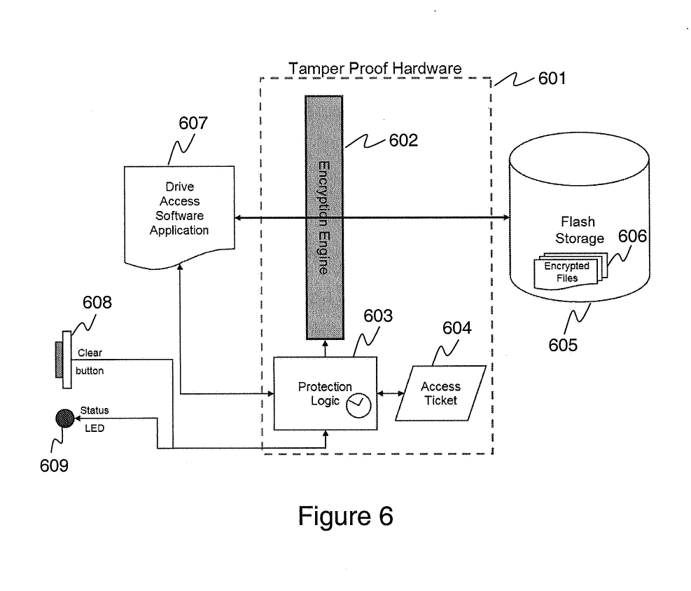

FIG. 6 illustrates an exemplary architecture of the hardware based implementation of the inventive technology. In this embodiment the information necessary to decrypt the flash storage is stored within the tamper-proof hardware 601. This information is preserved as long as the access ticket is valid.

The integral elements of a hardware implementation are depicted in FIG. 6. The drive incorporates an encrypted area 605 where encrypted shared files 606 are placed, hardware based encryption/decryption engine 602, a drive access application 607, which is executed on the computer system but available in an unencrypted form on the drive, optional status LED 609 and erase button 608. In addition, the hardware implementation includes a secure computational and storage element which is operable to store the decryption key for the encrypted files stored in flash memory; delete the cached decryption key; read and write the access ticket data; detect a new insertion of the drive into a USB host; determine the current (or elapsed) time; access the status LED and state of the clear button; determine the validity of the access ticket given the above inputs and delete the cached decryption key when it is no longer valid (too many accesses or time out of range) and control whether the flash memory area in FIG. 6 is read-only or read-write and control access appropriately.

The access ticket area (604) is accessible only to authorized users (password protected by the protection logic) to prevent a malicious host from rewriting the access ticket information to indefinitely extend the access. To make the drive highly secure the protection logic must be built in a tamper proof hardware (601), ensuring that the access ticket and cached decryption information are not retrievable through physical deconstruction of the hardware.

When the drive is inserted into a USB slot of a computer system, the protection logic performs a check of the time and number of permitted insertions as described in the access ticket data, and if the ticket is no longer valid, the cached information that allows the drive to decrypt the stored data without password entry is deleted.

Likewise, if the clear button 608 is pressed, the decryption information is erased. Note that the inventive system can be implemented with a second partition or encrypted area that operates as a standard encrypted drive—i.e.: it can not be shared through the protection logic. This area would be useful for normal storage of encrypted data for the drive owner.

In one embodiment the device is self-powered such that it can proactively secure itself by erasing its cached decryption information when the allotted time expires. In another embodiment, the drive may require the bus power to perform the deletion operation, in which case erasure of the data would occur only when power is applied.

It should be noted that because the drive needs to check the time, is it preferable to use the drive's integrated clock 603, rather than the foreign computer system clock, which does not have to be trusted. In one embodiment, the embedded clock employs a standard small battery (such as a watch battery) to power the clock's logic. In another embodiment, because the time periods for which an access ticket will be granted are generally short (minutes or hours not days) the drive incorporates a low-capacity rechargeable element which will suffice to run the clock for the short time needed. The power source can be recharged whenever plugged into a USB port eliminating the need for battery changes. It should be noted that the use of an embedded clock requires special driver software or increased processing internal to the key hardware.

An embodiment of the invention incorporates a physical switch or button on the flash drive which operates to delete or invalidate a previously granted access immediately. This allows the owner to make sure that any transient access permissions were cleared without having to insert the USB device. In addition, the LED 609 on the USB device can be provided to indicate whether or not the drive will have access the next time it is inserted.

### A Software-Based Implementation When a Network Connection is Not Available

A slightly different functionality can be achieved through a strictly software-based implementation of the inventive system. In this system, a public/private key pair is shared between the drive owner and the receiving party with whom data is to be shared. In this embodiment, the receiving user inserts the inventive USB drive into the target computer system. Drive access program generates public/private key pair for the receiving user and the target computer system, writes the generated public key on the USB drive and stores private key on the target computer system in the space of the receiving user.

This establishes the secure channel to the receiving user using the target computer system. Anyone in possession of the USB drive can subsequently use the public key stored on the drive to securely encrypt data for the receiving user. After that, the USB drive is inserted into the source computer system and the drive access program is executed. The drive access program displays icons corresponding to the receiving user and/or the target computer system and all other user/machine pairs with public keys on the drive.

After that, the user providing the shared information drags/drops files onto the icon corresponding to the key pair associated with the target computer system and/or receiving user or otherwise designates files and a set of user/machine pairs to share them with. The designated files are encrypted with the public key of the corresponding target computer system and/or receiving user and stored on the disk.

USB drive is then inserted into the target computer system and the drive access program is executed. The program finds the private key stored on target computer system, which corresponds to the public key used in the encryption of the files and decrypts all files for the target computer and/or the receiving user using the found key. The decrypted data is subsequently copied onto the target computer system.

The first step involving the creation and copying of the public key onto the drive needs to be done only once for each possible destination computer system. It will be appreciated by those of skill in the art that multiple public keys can be on the same disk. Each key pair designates a one-way channel. On the other hand, for symmetric communication, both the providing user and the receiving user can initialize a key pair exchange using the drive.

In one embodiment of the invention, a single file can be shared with multiple targets simultaneously without making multiple encrypted copies of the data, which is desirable if the data to be shared is large. In this embodiment, the data to be shared is encrypted with a randomly chosen session key (for instance a randomly chosen AES cipher) and a copy of this session key is encrypted with the public key for each desired recipient and stored (in encrypted form) on the USB disk. The receiving user then decrypts the session key with his private key and uses the session key to decrypt the data. In this way, the public/private key pairs are used because encryption/decryption with typical public/private keys is very computationally expensive compared to methods such as AES. Thus, the data is encrypted with a fast method such as AES, and the AES session key is subsequently encrypted with the public key.

As would be appreciated by those of skill in the art, in this embodiment of the invention, multiple source systems can add data intended for the same destination using the public key which is stored on the USB drive without the need to generate additional passwords for different source systems. In addition, the aforesaid implementation provides data security against loss and theft and works with standard USB drives. Finally, the described implementation makes it possible for the user to encrypt files with own public key for his or her personal use without requiring any passwords, by simply inserting the drive into his or her own computer system.

It would be appreciated that this method does not quite realize the usability of the hardware-based implementation because the USB drive must be given to the receiving person before the user providing the data can use it to share a file.

### A Software-Based Implementation When a Network Connection is Available

This implementation is somewhat related to the one discussed above, but uses a trusted network server to hold one half of a public/private key pair. Specifically, while connected to the network the user providing the data initializes the USB drive. A public/private key pair is then generated. The private key is stored on the computer system of the user providing data and the public key is stored on a trusted network host. This is a one-time initialization for the drive.

At some future time when the source computer system is potentially not connected to the network, the user providing the data designates a file to share with the USB drive. The file is encrypted with a session key. The session key is saved along with access ticket information describing the time period and number of accesses for which the data should be made available and encrypted with the private key previously created.

The receiving user of the target computer system (which is connected to the network) can insert the drive and run the drive access application. The application sends the encrypted access ticket to the trusted server, which can decrypt the access ticket (with the drive's public key), determine its validity, and if the ticket is found to be still valid, return to the application the unencrypted session key, thus granting data access to the target computer system.

As would be appreciated by those of skill in the art, this embodiment can be implemented completely in software based on standard USB storage devices. The time and number of accesses can be evaluated by the trusted server before granting access to the encrypted data and the drive can be used for sharing data with multiple people on time-based basis without authorizing each receiving user and/or target computer system.

As would be readily seen by one of ordinary skill in the art, this embodiment requires a trusted network server to hold part of the key pair for a drive. In addition, the recipient in the sharing operation needs to have a network access.

### Relationship Between the Various Implementations

The three embodiment described above are all similar in that when the drive is inserted in the third party computer system (recipient's computer system) the third party has access to the information needed to decrypt the shared files. In the hardware based embodiment, this information is cached within the drive hardware itself. In the software based embodiment, the decryption information has been stored on the receiving user's computer system in the form of the private key. In the case of the network-based embodiment, the decryption information is retrieved from the trusted network server. These three different implementations are all similar in that they provide a method to securely communicate the decryption key to the third party computer system without requiring the manual entry of a password.

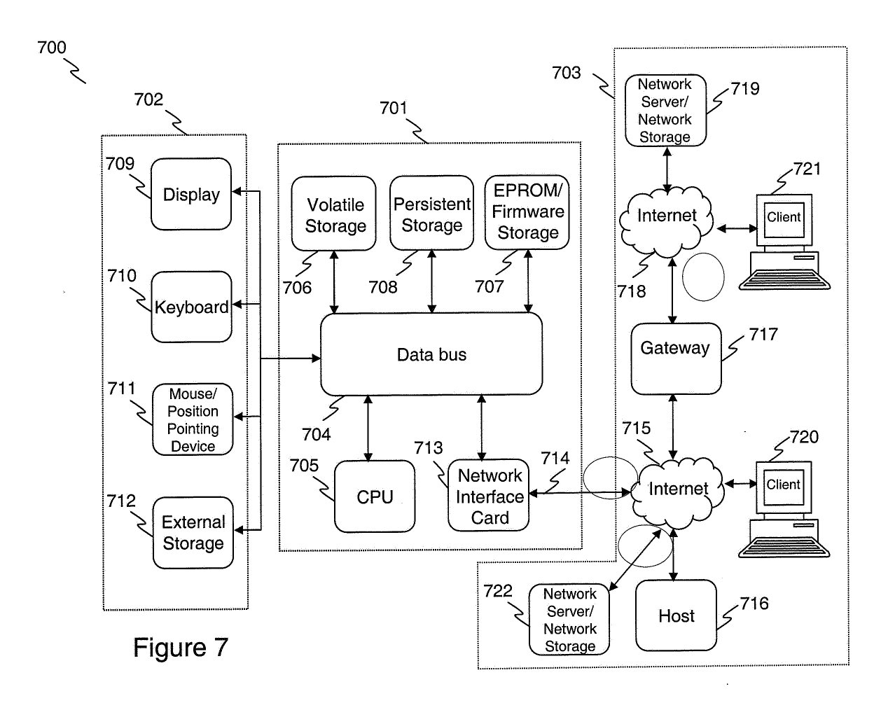

FIG. 7 is a block diagram that illustrates an embodiment of a computer/server system 700 upon which various aspects of the inventive methodology may be implemented. The system 700 includes a computer/server platform 701, peripheral devices 702 and network resources 703.

The computer platform 701 may include a data bus 704 or other communication mechanism for communicating information across and among various parts of the computer platform 701, and a processor 705 coupled with bus 701 for processing information and performing other computational and control tasks. Computer platform 701 also includes a volatile storage 706, such as a random access memory (RAM) or other dynamic storage device, coupled to bus 704 for storing various information as well as instructions to be executed by processor 705. The volatile storage 706 also may be used for storing temporary variables or other intermediate information during execution of instructions by processor 705. Computer platform 701 may further include a read only memory (ROM or EPROM) 707 or other static storage device coupled to bus 704 for storing static information and instructions for processor 705, such as basic input-output system (BIOS), as well as various system configuration parameters. A persistent storage device 708, such as a magnetic disk, optical disk, or solid-state flash memory device is provided and coupled to bus 701 for storing information and instructions.

Computer platform 701 may be coupled via bus 704 to a display 709, such as a cathode ray tube (CRT), plasma display, or a liquid crystal display (LCD), for displaying information to a system administrator or user of the computer platform 701. An input device 710, including alphanumeric and other keys, is coupled to bus 701 for communicating information and command selections to processor 705. Another type of user input device is cursor control device 711, such as a mouse, a trackball, or cursor direction keys for communicating direction information and command selections to processor 704 and for controlling cursor movement on display 709. This input device typically has two degrees of freedom in two axes, a first axis (e.g., x) and a second axis (e.g., y), that allows the device to specify positions in a plane.

An external storage device 712 may be connected to the computer platform 701 via bus 704 to provide an extra or removable storage capacity for the computer platform 701. In an embodiment of the computer system 700, the external removable storage device 712 may be used to facilitate exchange of data with other computer systems.

The invention is related to the use of computer system 700 for implementing the techniques described herein. In an embodiment, the inventive system may reside on a machine such as computer platform 701. According to one embodiment of the invention, the techniques described herein are performed by computer system 700 in response to processor 705 executing one or more sequences of one or more instructions contained in the volatile memory 706. Such instructions may be read into volatile memory 706 from another computer-readable medium, such as persistent storage device 708. Execution of the sequences of instructions contained in the volatile memory 706 causes processor 705 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 705 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 708. Volatile media includes dynamic memory, such as volatile storage 706. Transmission media includes coaxial cables, copper wire and fiber optics, including the wires that comprise data bus 704. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 705 for execution. For example, the instructions may initially be carried on a magnetic disk from a remote computer. Alternatively, a remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on the data bus 704. The bus 704 carries the data to the volatile storage 706, from which processor 705 retrieves and executes the instructions. The instructions received by the volatile memory 706 may optionally be stored on persistent storage device 708 either before or after execution by processor 705. The instructions may also be downloaded into the computer platform 701 via Internet using a variety of network data communication protocols well known in the art.

The computer platform 701 also includes a communication interface, such as network interface card 713 coupled to the data bus 704. Communication interface 713 provides a two-way data communication coupling to a network link 714 that is connected to a local network 715. For example, communication interface 713 may be an integrated services digital network (ISDN) card or a modem to provide a data communication connection to a corresponding type of telephone line. As another example, communication interface 713 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 713 sends and receives electrical, electromagnetic or optical signals that carry digital data streams representing various types of information.

Network link 713 typically provides data communication through one or more networks to other network resources. For example, network link 714 may provide a connection through local network 715 to a host computer 716, or a network storage/server 717. Additionally or alternatively, the network link 713 may connect through gateway/firewall 717 to the wide-area or global network 718, such as an Internet. Thus, the computer platform 701 can access network resources located anywhere on the Internet 718, such as a remote network storage/server 719. On the other hand, the computer platform 701 may also be accessed by clients located anywhere on the local area network 715 and/or the Internet 718. The network clients 720 and 721 may themselves be implemented based on the computer platform similar to the platform 701.

Local network 715 and the Internet 718 both use electrical, electromagnetic or optical signals that carry digital data streams. The signals through the various networks and the signals on network link 714 and through communication interface 713, which carry the digital data to and from computer platform 701, are exemplary forms of carrier waves transporting the information.

Computer platform 701 can send messages and receive data, including program code, through the variety of network(s) including Internet 718 and LAN 715, network link 714 and communication interface 713. In the Internet example, when the system 701 acts as a network server, it might transmit a requested code or data for an application program running on client(s) 720 and/or 721 through Internet 718, gateway/firewall 717, local area network 715 and communication interface 713. Similarly, it may receive code from other network resources.

The received code may be executed by processor 705 as it is received, and/or stored in persistent or volatile storage devices 708 and 706, respectively, or other non-volatile storage for later execution. In this manner, computer system 701 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, per, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in a removable storage drive. It is intended that the specification and examples be considered as exemplary only, with a true scope and spirit of the invention being indicated by the following claims.

What is claimed is:

1. A data storage device comprising:
a. An interface operable to connect the data storage device to a host system;
b. A storage area; and
c. A drive control program, wherein upon connection of the data storage device to a source host system using the interface, the drive control program is operable to:
i. Determine if the data storage device is unlocked;
ii. Validate a password and unlock the data storage device if the data storage device is determined to be locked;
iii. Receive selected file information from a user;
iv. Receive option information from the user;
v. Copy the selected files to the storage area; and
vi. Save ticket information to the data storage device.

2. The data storage device according to claim 1, wherein the option information comprises information on whether a recipient can modify the selected files.

3. The data storage device according to claim 1, wherein the option information comprises information on number of allowed connections of the data storage device to host systems.

4. The data storage device according to claim 1, wherein the option information comprises ticket expiration time.

5. The data storage device according to claim 1, wherein the option information specifies that a next host to mount the data storage device is to be added to a whitelist.

6. The data storage device according to claim 1, wherein the storage area is a transient storage area.

7. The data storage device according to claim 1, wherein the selected files are stored in the storage area in an encrypted form.

8. The data storage device according to claim 7, wherein upon connection of the data storage device to a target host system using the interface, the drive control program is operable to:
1. determine if a whitelist is used;
2. verify a hardware address of the target host against the whitelist, if the whitelist is used;
3. verify the validity of the ticket information on the data storage device; and
4. decrypt the encrypted selected files stored in the storage area of the data storage device.

9. The data storage device according to claim 8, wherein the drive control program is operable to verify the validity of the ticket information on the data storage device by obtaining a current time and comparing the obtained current time with at least a portion of the ticket information.

10. The data storage device according to claim 9, further comprising a clock unit operable to furnish the current time to the drive control program.

11. The data storage device according to claim 9, wherein upon determination that the ticket information has expired, the drive control program is operable to remove the ticket information from the drive and initiate a regular login session.

12. The data storage device according to claim 8, wherein the drive control program is further operable to add the hardware address of the target host to the whitelist.

13. The data storage device according to claim 8, wherein the drive control program is further operable to verify whether a number of allowed connections is exceeded and if so, remove the ticket information from the data storage device.

14. A data storage device comprising:
a. An interface operable to connect the data storage device to a host system;
b. A storage area; and
c. A drive control program, wherein upon connection of the data storage device to a target computer using the interface, the drive control program is operable to:
i. Obtain a public and private keys for the target computer;
ii. Store the public key to the data storage device; and
iii. Store the private key on the target computer;
and wherein upon subsequent connection of the data storage device to a source computer using the interface, the drive control program is further operable to:
iv. Receive selected file information from a user;
v. Encrypt the selected files using the stored public key; and
vi. Copy the encrypted selected files to the storage area.

15. The data storage device according to claim 14, wherein upon second connection of the data storage device to a target computer using the interface, the drive control program is further operable to:
i. Read the encrypted selected files from the storage area of the data storage device; and
ii. Decrypt the selected files using the private key store on the target computer.

16. A data storage device comprising:
a. An interface operable to connect the data storage device to a host system;
b. A storage area; and
c. A drive control program, wherein upon connection of the data storage device to a source host using the interface, the drive control program is operable to:
i. Obtain a public and private keys;
ii. Store the private key on the source host;
iii. Store the private key on a remote network server;
iv. Receive selected file information from a user;
v. Encrypt the selected files using a session key and store the encrypted selected files to the storage area; and
vi. Encrypt the session key and ticket information with the private key and store the session key and the ticket information to the data storage device;
and wherein upon subsequent connection of the data storage device to a target host using the interface, the drive control program is further operable to:
vii. Request the remote network server to validate the ticket information;
viii. If the ticket information is found to be valid, receive from the remote network server the session key; and
ix. Decrypt the encrypted selected files using the received session key.

17. The data storage device according to claim 16, wherein the remote network server is operable to validate the ticket information by comparing the time portion of the ticket information with the current time.

18. The data storage device according to claim 16, wherein the remote network server is operable to validate the ticket information by verifying if number of allowed connection has been exceeded.

19. A data storage device comprising:
a. An interface operable to connect the data storage device to a host system;
b. A secure key storage area operable to store an encryption key;
c. An encryption engine operable to encrypt information with the encryption key;
d. A storage area operable to store the encrypted information;
e. A ticket storage area operable to store ticket information;
f. A protection logic comprising a clock, the protection logic operable to discard the information stored in the storage area or the encryption key if the ticket information is determined to be invalid; and
g. A drive access program, wherein upon connection of the data storage device to a source host system using the interface, the drive access program is operable to:
i. Receive selected file information from a user;
ii. Obtain encryption key and store the obtained encryption key to the secure key storage area;
iii. Copy the selected files to the storage area; and
iv. Save the ticket information to the ticket storage area.

20. The data storage device according to claim 19, further comprising a clear button operable to receive an instruction from a user to discard the contents of the data storage device and to cause the encryption key to be discarded.

21. The data storage device according to claim 19, further comprising an access status indicator operable to inform a user of an access status of the data storage device.
